(19) United States
(12) Patent Application Publication
(10) Pub. No.: US 2009/0117237 A1
(43) Pub. Date: May 7, 2009

(54) METHOD FOR ADJUSTING A WATER TEMPERATURE AND A PASTEURIZATION TUNNEL

(75) Inventors: Lars H. Hansen, Roskilde (DK); Lars S. Jkergaard, Kopenhagen (DK); Jorgen T. Nielsen, Alsgarde (DK)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: Sander Hansen A/S, Brondby (DK)

(21) Appl. No.: 12/065,397

(22) PCT Filed: Jun. 23, 2006
(86) PCT No.: PCT/EP06/06073

§ 371 Date: Jul. 3, 2008

(30) Foreign Application Priority Data
Sep. 8, 2005 (DE) 10 2005 042 783.9

(51) Int. Cl. A23L 3/00

(52) U.S. Cl. 426/231; 426/506; 99/325

(57) ABSTRACT

A method for adjusting or controlling the temperature of water released for product pasteurization, by taking into consideration the heat transfer into the products for the control of the water temperature. Further, a method for adjusting or controlling the water temperature for the water released for product pasteurization in several superimposed decks, by taking into consideration the water temperature in at least one deck located below the upper deck for the control of the water temperature. Also, corresponding pasteurization tunnels as well as a pasteurization tunnel with at least three superimposed decks, where the water for at least three decks is released to the products in the uppermost deck.

### CROSS REFERENCE TO RELATED APPLICATIONS

The present application claims the benefit of priority of International Patent Application No. PCT/EP2006/006073, filed on Jun. 23, 2006, which application claims priority of German Patent Application No. 10 2005 042 783.9, filed Sep. 8, 2005. The entire text of the priority application is incorporated herein by reference in its entirety.

### FIELD OF THE DISCLOSURE

The disclosure relates to a method for adjusting or controlling the temperature of water released for product pasteurization as well as to a pasteurization tunnel.

### BACKGROUND

Pasteurization tunnels by means of which products, such as for example bottles, cans or other containers can be pasteurized, are known. For this, the products are transported through the pasteurization tunnel and in the process contacted with water at a predetermined temperature, so that the products are heated and possibly also cooled again. For suited pasteurization, it is important for the products to comprise a sufficiently high temperature for a sufficiently long period to achieve good sterilization. To this end, in various zones of a pasteurization tunnel, various temperatures are adjusted with which the temperature of the products can be slowly increased and possibly subsequently slowly reduced again.

In the process, it is however also important to avoid excessive pasteurization so as not to excessively influence for example the taste of drinks or other food. It is therefore necessary for a suited pasteurization operation to purposefully adjust or control the temperature of the water released for pasteurization.

Furthermore, pasteurization tunnels are known in which products are not only passed through the tunnel in one level but in two levels (decks). It is thus for example possible to transport products on two decks, and water is only put onto the upper deck and then reaches the lower deck. At a sufficiently high flow of water, the temperature difference in the upper and the lower decks is relatively small, so that with good pasteurization of the products on the upper deck, good pasteurization of the products on the lower deck can also be expected.

A device and a method where water temperature is adjusted or controlled are known, for example, from the DE 103 10 047 A1.

### SUMMARY OF THE DISCLOSURE

It is the object of the present disclosure to provide a method and a pasteurization tunnel which permit an adjustment of the water temperature as optimal as possible for an optimal pasteurization result.

It is furthermore an object of the present disclosure to provide a pasteurization tunnel which has a high capacity and can have a relatively space-saving embodiment, respectively.

In the method of adjusting or controlling the water temperature, the heat transfer from the water into the products is taken into consideration. Such a control for example permits to take into consideration the cooling of the water during the contact with the products. This permits more accurate adjustments of the desired temperature of the water, so that controlled pasteurization of the products is permitted.

In an advantageous embodiment, the heat transfer into the products is taken into consideration, where the product temperature and water temperature in the corresponding products is considered. Furthermore, the feeding with products can be advantageously taken into consideration, i.e. the number, the weight or the like per time or any other quantity of products to be pasteurized.

In an advantageous embodiment, at least two, three or more decks are located one upon the other, and products for pasteurization are transported in the two decks. The water that leaves the upper deck is here used for pasteurizing the products in the deck below. The temperature of the water entering the lower deck will be determined taking into consideration the heat transfer in the deck located above.

In an advantageous embodiment, the temperature of the products is calculated from the heat transfer into the products.

A desired control value can be calculated for water temperature control in a suited manner from the calculated temperature of the products as the temperature of the products determines the pasteurization process. For each deck of the various superimposed decks, a desired control value can be calculated. From this plurality of desired control values, an individual control value can be determined which is used for the control. Here, various methods can be used to determine the control value to be used from the several desired control values. This can be, for example, the selection of a minimum value, a maximum value or that of an average value or a median or the like.

Advantageously, several control loops are provided which take into consideration several criteria. Thus, for example an additional control loop can be provided which concerns the observation of a temperature range above a minimum temperature and/or below a maximum temperature.

A method for controlling the water temperature is in particular advantageous if the control of the water temperature is performed in several successively arranged zones. The adjustment of the water temperature in the various zones, however, can interact, for example by exchanging parameters. It is thus possible, for example, that the temperature of the products resulting from the calculation in one zone is taken as input quantity for the control in an adjacent zone, for example the downstream zone.

For a method for controlling the water temperature of the water released for product pasteurization in several superimposed decks, it is provided to take into consideration the water temperature in at least one of the decks located below the upper deck. Here, the water is released for pasteurizing products in several decks and the temperature of the water in several decks is taken into consideration. The temperature of the water can here be calculated by model calculations or else be measured.

The pasteurization tunnel is characterized in that the heat transfer into the products is taken into consideration for the control of the water temperature.

Another pasteurization tunnel where water is released for product pasteurization in several superimposed decks is characterized in that the water temperature in several decks is taken into consideration.

Another pasteurization tunnel is furthermore characterized by three superimposed decks where the water for the three decks is only released in the uppermost deck. The water is not released in the decks below, but the water of the superimposed deck is used in each deck.

### BRIEF DESCRIPTION OF THE DRAWINGS

Advantageous embodiments of the disclosure will be illustrated with reference to the enclosed figures. In the figures:

FIG. 1 shows a schematic section of a pasteurizer with three decks;

FIG. 2 shows a schematic representation of a control loop;

FIG. 3 shows a schematic representation of another control loop;

FIG. 4 shows a schematic representation of still another control loop;

### DETAILED DESCRIPTION OF THE PREFERRED EMBODIMENT

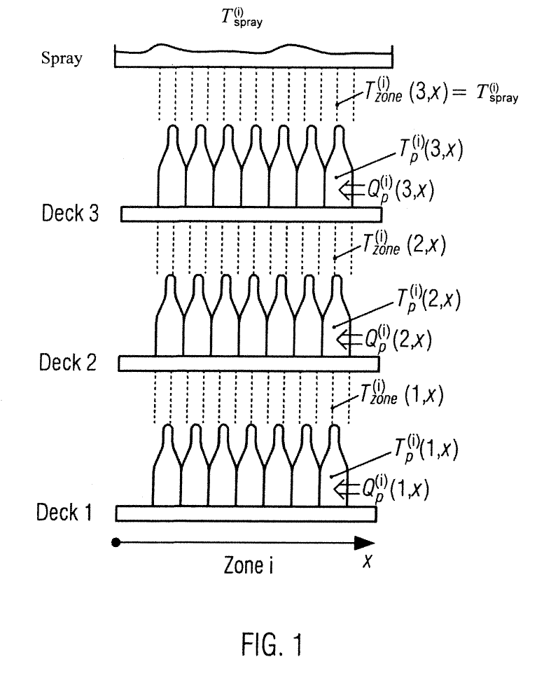

In FIG. 1, a schematic section through a pasteurization tunnel is shown. The pasteurization tunnel comprises three decks on which products (here bottles filled with beer and sealed) can be transported. The three decks are arranged one upon the other. Above the uppermost deck, there is a spraying array by means of which water can be sprayed onto the products on deck 3.

These decks are permeable to water, so that the water sprayed onto the bottles in deck 3 can flow to the bottles in deck 2, and from there to the bottles in deck 1.

In FIG. 1, a zone i is shown for which a certain temperature or a temperature profile is distinctive. Various zones are arranged successively, wherein the products are transported through the various zones.

The temperature of the sprayed-out water in zone i is referred to as T_{spray}⁽ⁱ⁾. T_{zone}⁽ⁱ⁾(j, x) denotes the temperature in zone i in deck j at position x. The temperature in the uppermost deck (deck 3) is here equal to the spray temperature. The temperature of the products in deck j is denoted with T_{P}⁽ⁱ⁾(j, x), where j is the number of the deck and x is the position in the zone i.

Due to a temperature difference between the temperature of the water and the temperature of the products, a heat transfer into the products takes place. The amount of heat passing into the products in the respective deck is referred to as Q_{P}⁽ⁱ⁾(j, x), where j is the number of the deck and x the position of the products.

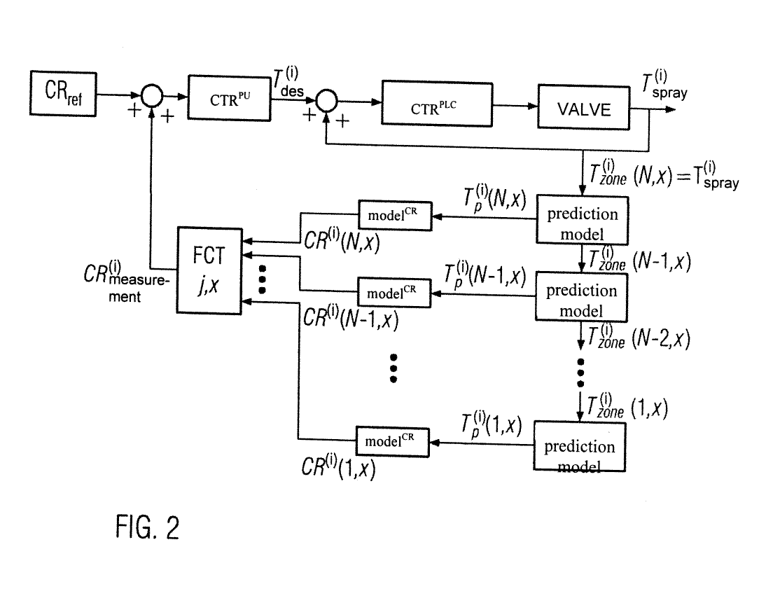

In FIG. 2, the control loop is represented schematically. CRref denotes a control target value, such as, for example, a number of PU units or a control parameter for a TAT(time above temperature)-control.

Reg^{CR} denotes a unit which calculates the desired temperature T_{des}⁽ⁱ⁾. This desired temperature is entered into a sub-control loop which adjusts the temperature of the spray water T_{spray}⁽ⁱ⁾ for zone i via a valve controlled distribution of a hot water supply.

This spray water temperature corresponds to the water temperature in the uppermost deck of the corresponding zone. A prediction model is used to predict the temperature of the products as well as the temperature of the water exiting from the respective deck. To this end, the heat transfer into the products is taken into consideration. By the heat transfer, the water for example cools down so that the temperature of the water in a lower deck is lower than the temperature of the spray water in an upper deck.

With the prediction model, the temperature T_{zone}⁽ⁱ⁾(N−1, x) is thus calculated from the zone temperature T_{zone}⁽ⁱ⁾(N, x). Here, the amount of the products to be pasteurized (feed) is also taken zone into consideration. The more products are located in zone i, the more the temperature of the water in a deck in the corresponding zone is changed.

A desired control value CR⁽ⁱ⁾ (j, x) is calculated in each case from the product temperature T_{P}⁽ⁱ⁾ (j, x), for deck j. To this end, a control-specific model is used which gives suited values for CR. This can be for example the number of the accepted PU units or the PU units still to be accepted, or the like.

From the plurality of CR values for the various decks, an individual CR value is determined with a function FCT. This value is referred to as CR measurement and quasi entered as actual value into the control unit for the water temperature control. In this manner, the desired control value CRref is achieved.

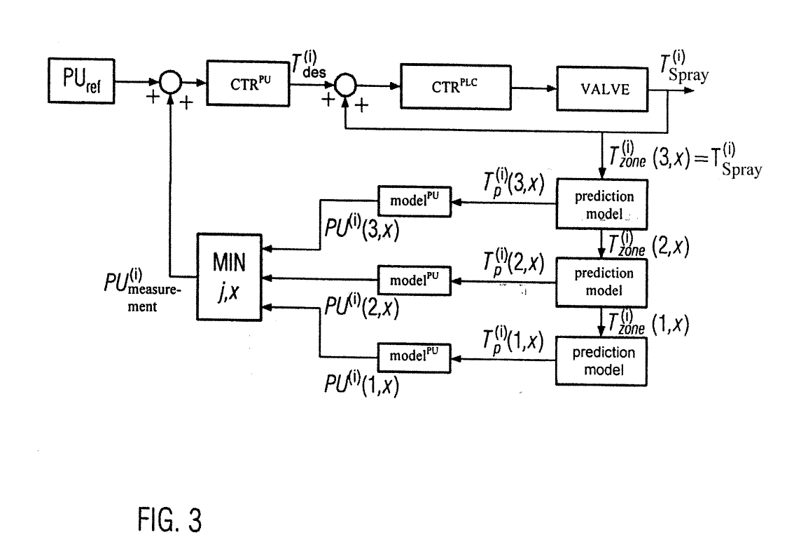

In FIG. 3, an example of a concrete control is shown where there are three decks and a PU unit control is performed.

Here, for example models model^{PU} are provided which calculate the corresponding PU units from the temperature of the products. As function FCT, a minimum function is provided which takes the smallest PU value of the calculated PU values as controlled variable PUₘₑₐₛᵤᵣₑₘₑₙₜ⁽ⁱ⁾. It is thus ensured that in all decks the desired minimum number of PU units is achieved.

As input variable for the control loop PUref, for example a number of desired PU units can be stated which are to be fed in zone (i).

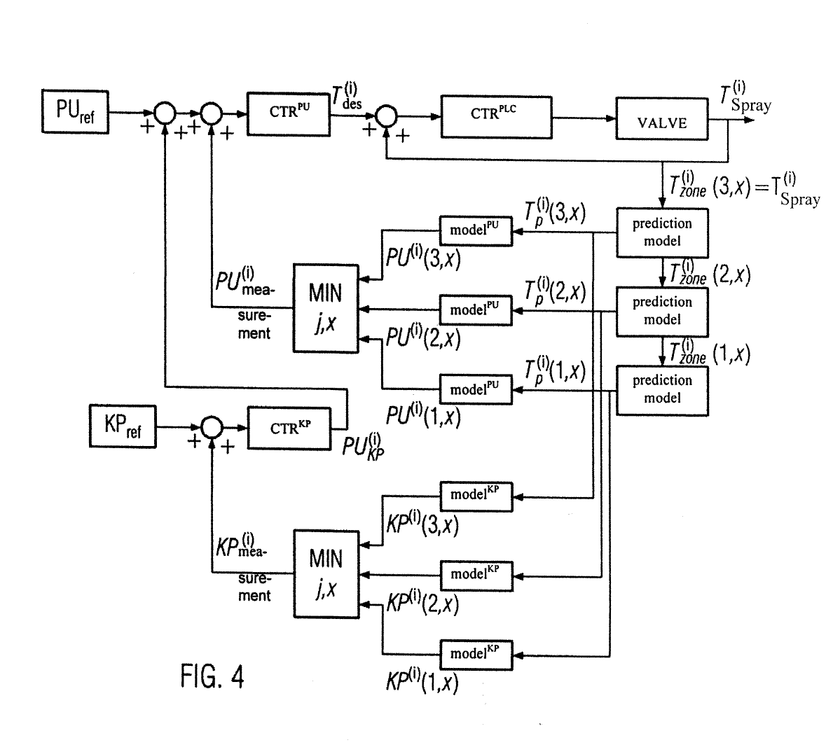

In FIG. 4, a further control loop is added which ensures that the temperature of the products in one zone is above the KP temperature (killing point temperature), where this temperature denotes the temperature as from which sterilization occurs. It is possible that sufficient PU units are also fed at low temperatures, however without sufficient sterilization being performed. To avoid this, such a control loop with several control criteria is advantageous.

Apart from the observation of a minimum temperature, a maximum temperature can also be taken into consideration for the products if the products are very temperature-sensitive.

1. Method for adjusting or controlling the temperature of water released for product pasteurization, comprising:
releasing a volume of water having a temperature suitable to pasteurize a product, and
controlling the water temperature, utilizing the rate of heat transfer into the products.

2. Method according to claim 1, and calculating the rate of heat transfer into the products, utilizing the product temperature and water temperature of the corresponding products.

3. Method according to claim 1, and determining the rate of heat transfer, utilizing the loading with products.

4. Method according to claim 1, and using the water released for product pasteurization in at least two, superimposed decks, and determining the temperature of the water in at least one of the decks below the uppermost deck utilizing the rate of heat transfer in at least one of the decks.

5. Method according to claim 1, and calculating the temperature of the products from the heat transfer into the products.

6. Method according to claim 5, and for each deck calculating a desired control value for the water temperature control from the temperature of the products in superimposed decks, and determining an individual control value from the desired control values.

7. Method according to claim 1, and providing for observation of at least two control loops for controlling the water temperature

8. Method according to claim 1, and performing the control of the water temperature separately in several zones arranged in series.

9. Method for adjusting or controlling the temperature of water released for product pasteurization in several superimposed decks, comprising
utilizing the water temperature in at least one deck located below the upper deck for the control of the water temperature.

10. Pasteurization tunnel with a control for adjusting or controlling the temperature of water released for product pasteurization, comprising
means for utilizing the heat transfer into the products for the adjustment of the water temperature.

11. Pasteurization tunnel with a control for adjusting or controlling the temperature of water released for product pasteurization in several superimposed decks, comprising
means for controlling the water temperature wherein the water temperature in at least one deck located below the upper deck is utilized.

12. Pasteurization tunnel, comprising at least three superimposed decks, and the water for the at least three decks being released to the products in the uppermost deck.

13. Method according to claim 7, and with one of the control loops observing one of a minimum temperature, a maximum temperature, and both a minimum and maximum temperatures.

14. The pasteurization tunnel according to claim 12, and means for determining the water temperature at a lower deck for adjusting the temperature of the water released at the uppermost deck.
